(19) United States
(12) Patent Application Publication
(10) Pub. No.: US 2006/0053676 A1
(43) Pub. Date: Mar. 16, 2006

(54) Bait tongs for handling fish

(76) Inventor: Michael D. Mullen, Northfield, NJ (US)

Correspondence Address: Hollstein Keating Cattell Johnson & Goldstein P.C., Willow Ridge Executive Office Park, 750 Route 73 South, Suite 301, Marlton, NJ, 08053, US

(21) Appl. No.: 10/940,476

(22) Filed: Sep. 14, 2004

(51) Int. Cl. A01K 97/00

(52) U.S. Cl. 43/5

(57) ABSTRACT

Tongs are formed by two arm members pivotly connected at one end. Each of the arm members has a plurality of sharp, pointed, pikes at their respective ends. The pikes are designed to grip the outer surface of slippery fish, including eel type fish. An extension plate extends outwardly at the end of one of the arm members to assist in securing and maintaining the fish between the arm members.

### BACKGROUND OF THE INVENTION

Tongs have long been used to lift a variety of types of items, especially foodstuffs, ice and other things which are difficult to grasp. While tongs come in a variety of shapes and configurations, and some are specifically designed to handle certain products, there are no tong type devices particularly adapted to efficiently and readily handle and lift fish, especially eel type fish, which are uniquely slippery and difficult to grasp and securely hold. This is particularly a problem in fishing situations while handling bait, e.g. small eel and similar fish. It is almost impossible to grab this type of fish with one's bare hands or even with specially adapted gloves and there is no way of grabbing and securely holding this type of fish with a device which otherwise does not require some direct contact between the fish and the fisherman's hand.

### SUMMARY OF THE INVENTION

It is thus the object of the present invention to overcome the disadvantages and limitations of prior tong devices.

It is an object of the present invention to provide tongs which are configured to allow the user to readily and easily grasp hold of, handle, and lift fish, especially slippery fish such as eels.

It is a further object of the present invention to provide tongs which permit the grasping, lifting, and handling of all types of fish, including eels, for purposes fish baiting, lifting and handling of fish from a tank, or for any purpose in which fish must be handled, lifted, and transported.

It is still another object of the present invention to provide tongs which allow for the grasping, lifting, and handling of fish without direct contact between the users hand and the fish.

It is a further object of the present invention to provide tongs which provide a secure grip of the fish being handled.

These and other objects are provided by the present invention, tongs which are formed by two arm members pivotly connected at one end. Each of the arm members has a plurality of sharp, pointed, pikes at their respective ends. The pikes are designed to grip the outer surface of slippery fish, including eel type fish. An extension plate extends outwardly at the end of one of the arm members to assist in securing and maintaining the fish between the arm members.

The novel features which are considered as characteristic of the invention are set forth in particular in the appended claims. The invention itself, however, as to its design, construction, and use, together with additional features and advantages thereof, are best understood upon review of the following detailed description with reference to the accompanying drawings.

### BRIEF DESCRIPTION OF THE DRAWINGS

FIG. 1 is a front view of the tongs of the present invention.

FIG. 2 is a side view of the tongs of the present invention.

FIG. 3 is the opposite side view of the tongs of the present invention.

FIG. 4 is a bottom view of the tongs of the present invention.

FIG. 5 is a top view of the tongs of the present invention.

FIG. 6 shows the tongs of the present invention in use.

FIG. 7 is a front view of an alternative embodiment of the tongs of the present invention.

FIG. 8 is a side view of an alternative embodiment of the tongs of the present invention.

FIG. 9 is the opposite side view of the alternative embodiment of the tongs of the present invention.

FIG. 10 is the top view of the alternative embodiment of the tongs of the present invention.

FIG. 11 is the bottom view of the alternative embodiment of the tongs of the present invention.

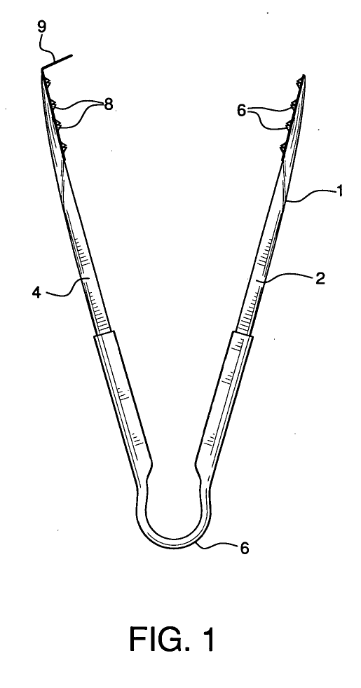

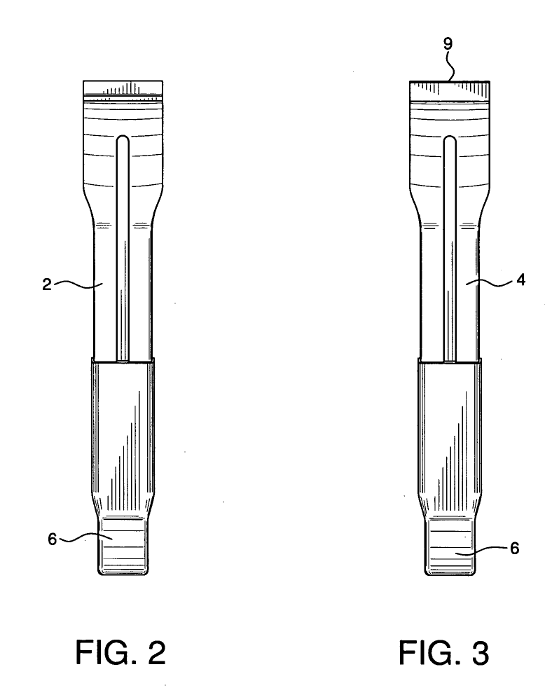

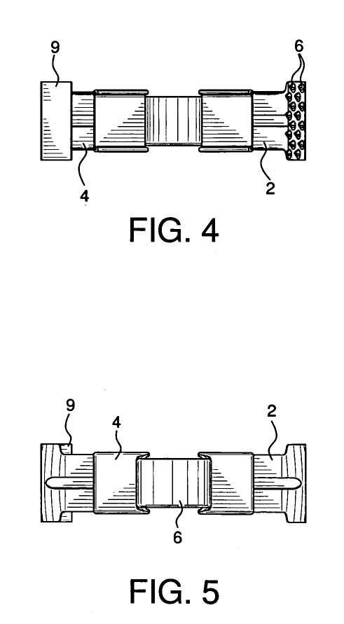

### DETAILED DESCRIPTION OF THE INVENTION

Tongs 1 comprise arm members 2 and 4 pivoted at their lower ends at resiliently formed section 6. Arm members 2 and 4 are pivotable in relation to each other, as a result of the resiliency allowed by section 6, a feature which is known in the art.

Arm member 2 has a plurality of serially positioned, sharply pointed pike members 6 at its end. Similarly, arm member 4 has a plurality of serially positioned sharply pointed pike members 8 at its end. Extending outwardly from the distal end of arm member 4 is extension plate 9.

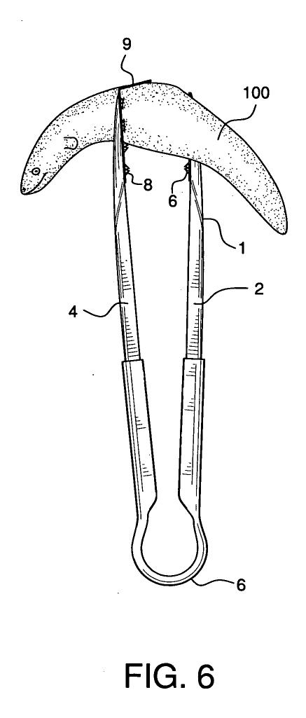

In use, arms 2 and 4 of tongs 1 are pivoted together to grab an eel or similar fish 100. Sharp pikes 6 and 8 grip the outer surface of the fish and secure it between the ends of arm members 2 and 4, while extension plate 9 confines the fish within the tongs, as shown in FIG. 6. It is contemplated that the length of extension 9 may vary, based on the size of fish to be held.

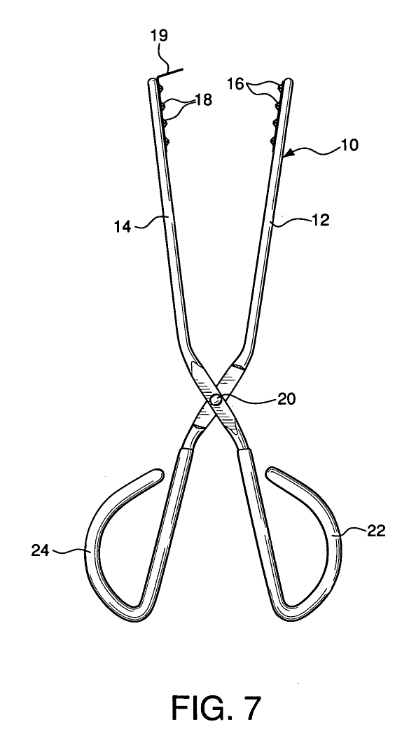

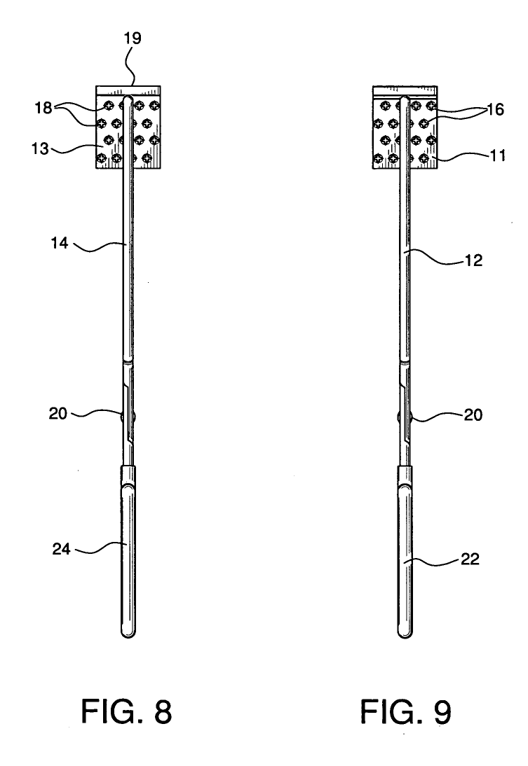

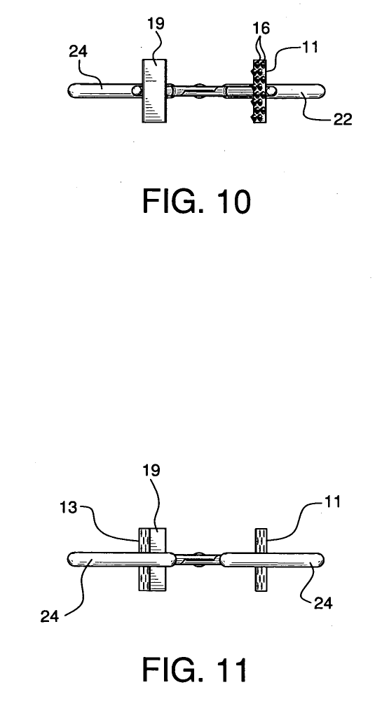

FIG. 7 shows an alternative embodiment of the tongs of the present invention. Tongs 10 comprise arm members 12 and 14. Plate 11, secured to the end of arm 12, comprises a plurality of sharply pointed pike members 16. Plate 13, secured to the distal end of arm member 14, comprises a plurality of sharply pointed pike members 18. Extension plate 19 extends outwardly from the distal end of plate 13. Arm members 12 and 14 are pivoted at rivet 20 and are moved side to side in relation to each other via handles 22 and 24, into which the user places his thumb and fingers. This scissors-like configuration of tongs 9 also provides an easy, effective and readily useable tong device.

Certain novel features and components of this invention are disclosed in detail in order to make the invention clear in at least one form thereof. However, it is clearly understood that the invention as disclosed is not necessarily limited to the exact form and details as disclosed, since it is apparent that various modifications and changes may be made without department from the spirit of the invention.

1. Tongs for handling and lifting fish, said tongs comprising;
a first elongated arm member pivotably connected to a second elongated arm member, the first arm member having a plurality of sharply pointed pike means located at its upper end for gripping the outer surface of fish, the second arm member having a plurality of sharply pointed pike means located at its upper end for gripping the outer surface of fish, said second arm member further comprising means extending outwardly from the distal end of the second arm member for assisting in handling and confining fish between both arm members of the tongs.

2. The tongs as in claim 1 wherein the first arm member is pivotly connected at its lower end to the lower end of the second member and the pike means are serially positioned at the ends of each member.

3. The tongs as in claim 1 further comprising a first handle located at the lower end of the first arm member and a second handle located at the opposite distal end of the second arm member.

4. The tongs as in claim 1 in which the first and second arm members are pivotably connected in scissors-like configuration.

5. The tongs as in claim 3 wherein the first and second arm members are pivotably connected in scissors configuration.

6. The tongs as in claim 1 further comprising a first plate secured to the first arm member and a second plate secured to the second arm member, the plurality of sharply pointed pike means of the first and second arm members extending from the first and second plates.
